(19) United States
(12) Patent Application Publication
(10) Pub. No.: US 2016/0157973 A1
(43) Pub. Date: Jun. 9, 2016

(54) APPARATUS FOR INTEGRATED TOOTHBRUSH AND FLOSS

(71) Applicant: Michael Greco, Lighthouse point, FL (US)

(72) Inventor: Michael Greco, Lighthouse point, FL (US)

(21) Appl. No.: 14/563,321

(22) Filed: Dec. 8, 2014

(51) Int. Cl. A61C 15/04; A46B 15/00

(52) U.S. Cl. CPC A61C 15/048; A46B 15/0055; A46B 2200/1066

(57) ABSTRACT

An integrated apparatus includes a toothbrush having a first end and a second end. Between the first and the second end of the toothbrush includes a head, a middle body and a lower body; the head being towards the first end, the lower body towards the second end. The middle body placed between the head and the lower body providing grip area for the apparatus. A plurality of bristles placed above the head of the toothbrush towards the first end. The lower body further includes a contour section, and a floss receptacle section. A floss assembly includes of a floss body and a floss, the floss assembly configured to attach to the floss receptacle section of the toothbrush. The contour section has an upper edge and a lower edge.

### BACKGROUND OF THE INVENTION

1. Field of the Invention

Embodiments of the present invention generally relate to a toothbrush, and more particularly to an apparatus for integrated toothbrush and floss.

2. Description of the Related Art

Dental hygiene is an important part of everyday life. Proper dental hygiene requires regular and frequent care. Proper dental hygiene is also best performed by using a variety of tools. For example, more complete dental hygiene is achieved by using dental floss in combination with brushing of the teeth. A problem results from having to use various tools to perform better dental hygiene because the person has to keep track of all of the tools that are needed. If only one tool, such as a toothbrush or dental floss is readily available, a person is likely to use only that tool and not look for the other tools that are needed. This results in the person not performing the complete dental hygiene regimen that provides the best dental hygiene.

In recent years, the benefits of using dental floss have been widely recognized and it is therefore desirable when traveling to use dental floss in addition to a toothbrush; however, it is cumbersome and inconvenient to pack both a toothbrush and a separate supply of dental floss.

Toothbrushes have been developed which include a dental floss holder within the body of the toothbrush. For example, U.S. Pat. No. 5,924,429 teaches a toothbrush comprising a detachable toothbrush and including a supply of dental floss disposed within the interior cavity of the toothbrush handle. U.S. Pat. No. 4,887,621 teaches a combination toothbrush and dental floss holder where the toothbrush includes a hollow handle including a cavity for storing a spool of dental floss.

Therefore, a need exists to overcome the problems with the prior art as discussed above. However, there is still a need in the art for an improved combination toothbrush and dental floss holder which is easy to make and use and which is for travel use.

### SUMMARY

In accordance with one embodiment, an integrated apparatus for toothbrush and floss is provided. The integrated apparatus includes a toothbrush having a first end and a second end. Between the first and the second end of the toothbrush includes a head, a middle body and a lower body; the head being towards the first end, the lower body towards the second end. The middle body placed between the head and the lower body providing grip area for the apparatus.

A plurality of bristles placed above the head of the toothbrush towards the first end. The lower body further includes a contour section, and a floss receptacle section. A floss assembly includes of a floss body and a floss, the floss assembly configured to attach to the floss receptacle section of the toothbrush.

The contour section has an upper edge and a lower edge. The upper edge of the contour section has a first vertex and a second vertex. The first vertex is adjacent to the middle body. The second vertex creates the lower end of the floss receptacle section. The lower edge connecting the first vertex and the second vertex at the bottom and is a level plane. The upper edge is a concave contour with indented slope between the first vertex and the second vertex enabling a user to seamlessly enter and exit the integrated device within the oral cavity. In one embodiment, the first vertex section of the toothbrush wider than the second vertex. In an alternate embodiment, the first vertex and the second vertex is of the same height. The contour between the between this first and second vertex is in the shape of a sickle.

The floss receptacle part of the integrated device has an inner section similar to a bracket shape “[” with curved corners. Additionally, the floss receptacle part has an outer section forming the continuous part of the level edge and a hook shaped end perpendicular to the level edge with curved corners. The integrated apparatus wherein the floss assembly having a floss body and a floss; the floss body similar to a bracket “[” shape with curved corners, configured to be received in the floss receptacle section; the floss body having a first arm and a second arm, each arm's proximal end attached to the floss body, the distal free end, the floss attached to the first arm and a second arm closer to the distal end.

The integrated apparatus wherein the floss first arm and the floss second arm are of equal length and at least twice the length of an arms of the floss receptacle section. The integrated apparatus wherein the floss is replaceably attached to the first arm and the second arm. The integrated apparatus wherein the floss assembly is replaceably connected to the floss receptacle. The integrated apparatus wherein the detachable floss assembly having a pivot part and a hook, the receptacle section further configured to provide an pivot space to receive the pivot part and a catch for receiving the hook.

The integrated apparatus wherein the attachment mechanism for receptacle section and the floss assembly includes receiving the pivot within the pivot space and then snapping the hook to the catch. The integrated apparatus wherein the detachment mechanism for receptacle section and the floss assembly includes first dethatching the pivot and then removing the hook from the catch. The integrated apparatus wherein the receptacle section includes a groove to accommodate the floss assembly. The integrated apparatus further includes a floss cap having an ornamental design in the outer shape of the floss assembly, the floss cap configured to snugly fit the toothbrush body enclosing the floss assembly. The integrated apparatus wherein the floss cap having two lips to encompass the floss assembly, the floss lips having two long sides and two short sides, wherein the one long side and one short side connected together with a continuous strip, the strip having a thickness equal to the thickness of the toothbrush, the lips and the strip side forming an enclosure with two side open. The integrated apparatus wherein the floss cap partially enclosed third side continuous strip. The integrated apparatus wherein the floss cap having a plurality of bulge towards inner ends of the lips includes a hinged lips rotatable over a plurality of matching depression on the brush body. The integrated apparatus wherein the floss cap is detachable.

### BRIEF DESCRIPTION OF THE DRAWINGS

The drawings, in which like numerals represent similar parts, illustrate generally, by way of example, but not by way of limitation, various embodiments discussed in the present document.

FIG. 1 illustrates a perspective view of an integrated toothbrush and floss apparatus in accordance with an embodiment.

FIG. 2 illustrates a bottom view of the integrated toothbrush and floss apparatus in accordance with an embodiment.

FIG. 3 illustrates a top view of the integrated toothbrush and floss apparatus in accordance with an embodiment.

FIG. 4 illustrates a perspective view of an alternate embodiment of an integrated toothbrush and floss apparatus with a floss cap in accordance with an embodiment.

FIG. 5 illustrates a perspective view of the alternate embodiment of the integrated toothbrush and floss apparatus without the floss cap in accordance with an embodiment.

FIG. 6 illustrates a perspective view of a floss assembly in accordance with an embodiment.

FIG. 7 illustrates a side perspective view of the floss assembly in accordance with an embodiment.

FIG. 8 illustrates a perspective view of the floss cap showing open sides in accordance with an embodiment.

FIG. 9 illustrates a perspective view of the floss cap showing closed sides in accordance with an embodiment.

### DETAILED DESCRIPTION

The foregoing summary, as well as the following detailed description of certain embodiments of the subject matter set forth herein, will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

To the extent that the term “includes” is used in either the detailed description or the claims, such term is intended to be inclusive in a manner similar to the term “comprising” as “comprising” is interpreted when employed as a transitional word in a claim. Furthermore, the term “or” as used in either the detailed description or the claims is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B.

In the following detailed description, reference is made to the accompanying drawings which form a part hereof, and in which are shown by way of illustration specific embodiments in which the subject matter disclosed herein may be practiced. These embodiments, which are also referred to herein as “examples,” are described in sufficient detail to enable those skilled in the art to practice the subject matter disclosed herein. It is to be understood that the embodiments may be combined or that other embodiments may be utilized, and that structural, logical, and electrical variations may be made without departing from the scope of the subject matter disclosed herein. The following detailed description is, therefore, not to be taken in a limiting sense, and the scope of the subject matter disclosed herein is defined by the appended claims and their equivalents. In the description that follows, like numerals or reference designators will be used to refer to like parts or elements throughout. In this document, the terms “a” or “an” are used, as is common in patent documents, to include one or more than one. In this document, the term “or” is used to refer to a nonexclusive or, unless otherwise indicated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

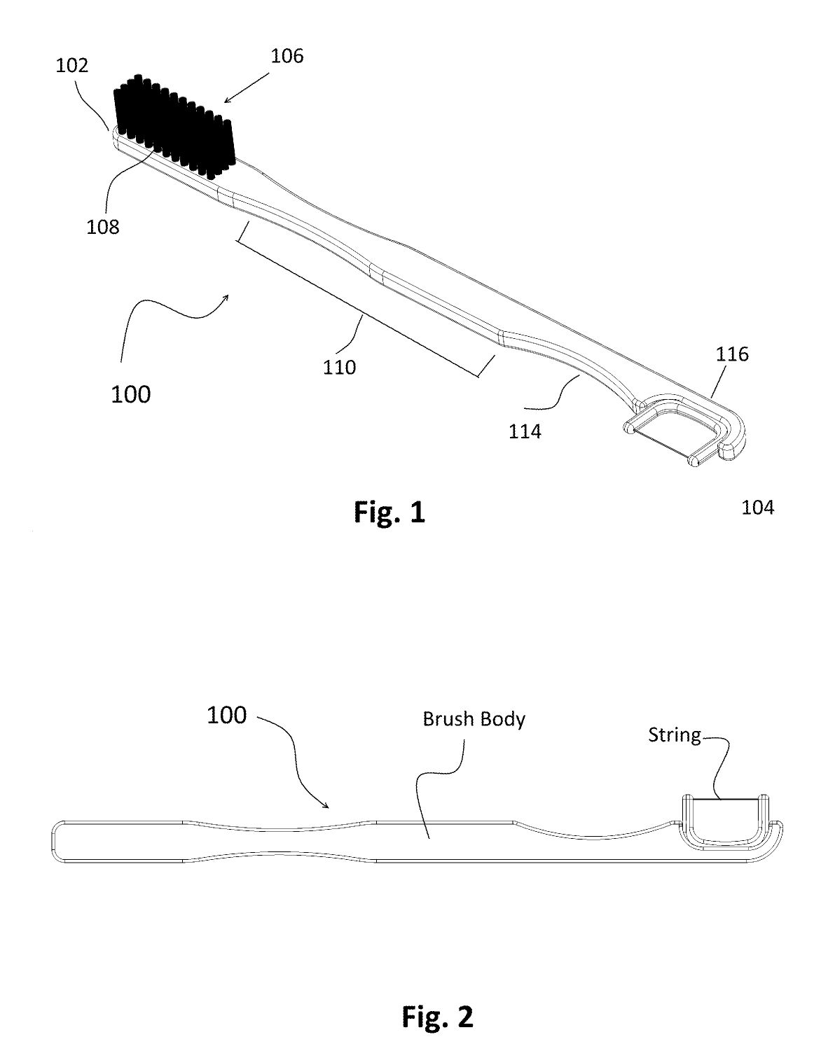

FIG. 1 illustrates a perspective view of an integrated toothbrush and floss apparatus 100 (hereinafter “integrated apparatus” or “toothbrush”) in accordance with an embodiment. The integrated apparatus in FIG. 1 has a first end 102 and a second end 104. As shown in the figure, the integrated apparatus 100 comprises of three parts between the first end 102 and the second end 104. The first part is a head 106 of the toothbrush 100. The head 106 of the toothbrush 100 provides a place for holding bristles 108 for brushing ones teeth.

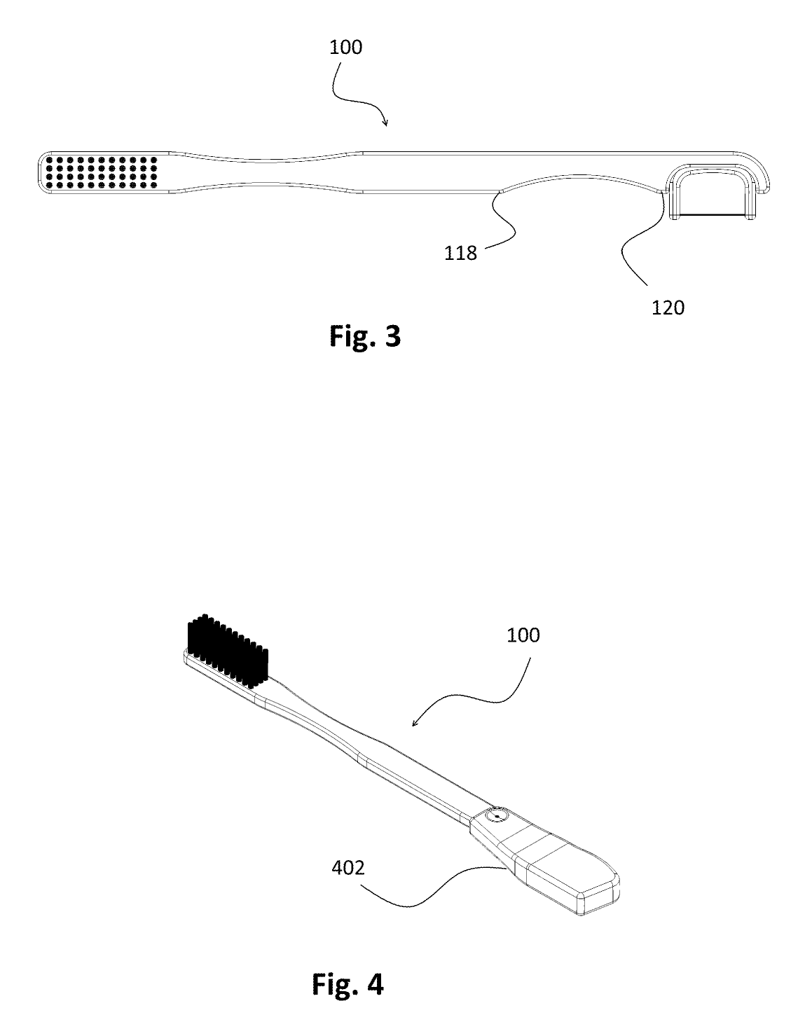

The bristles 108 are placed on the top surface of the head 106 of the toothbrush. FIG. 2 illustrates a bottom view of the integrated toothbrush 100 in accordance with an embodiment. FIG. 3 illustrates a top view of the integrated toothbrush 100 in accordance with an embodiment. As evident from the drawings the head 106 is positioned towards the first end 102 of the bristles 108.

The second part of the toothbrush 100 is a middle body 110 and the third part is a lower body 112. As intuitive to the reader the middle body 110 is placed between the head 106 and the lower body 112 and allows a user to hold the toothbrush 100. The lower body 112 further includes a contour section 114 and a floss receptacle section 116.

The contour section 114 is meant to make it easier for a user to insert the second end of the toothbrush into their mouth. Thus the contour seem matches the seam of the mouth thus is meant to fit the innermost recesses of the human mouth between its teeth and cheeks. Furthermore, the contour section 114 enables a user to seamlessly enter and exit the toothbrush in an out of their oral cavity.

The contour section 114 has a first vertex 118 and a second vertex 120. The first vertex 118 is adjacent to the middle body 110. The second vertex 120 is the lower end of the floss receptacle section 116. In accordance with one embodiment of the subject matter disclosed herein, the integrated apparatus' first vertex section 118 is wider than the second vertex 120.

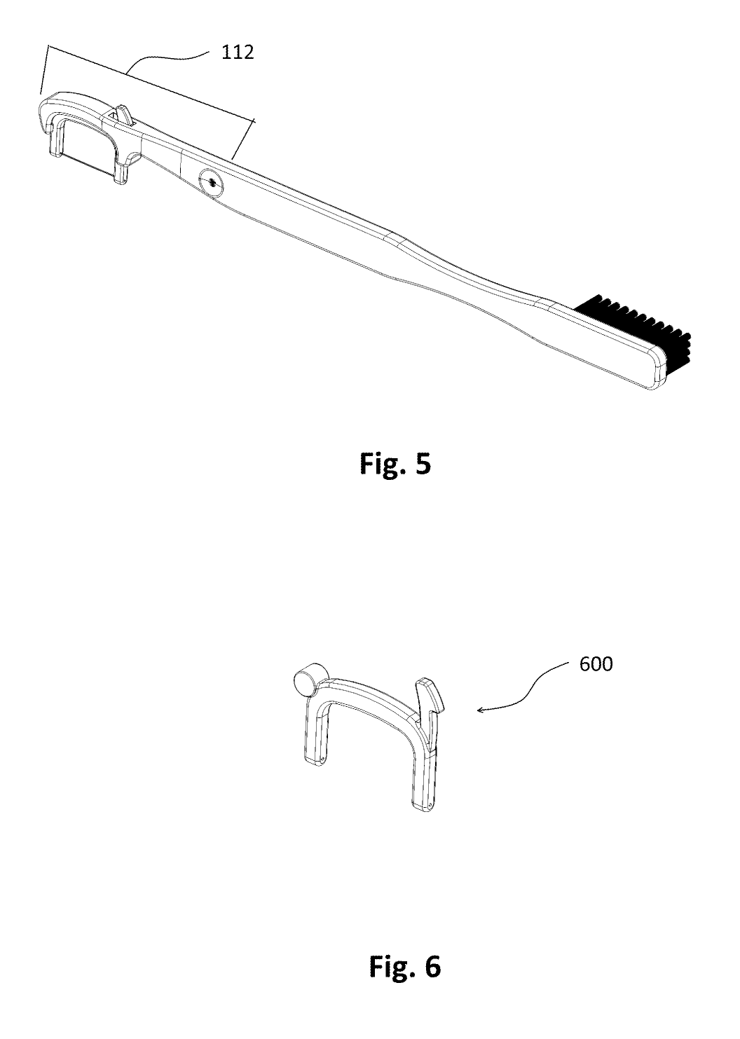

FIG. 4 illustrates a perspective view of an alternate embodiment of an integrated toothbrush 100 with a floss cap in accordance with an embodiment. A floss assembly includes of a floss body and a floss, the floss assembly configured to attach to the floss receptacle section of the toothbrush. FIG. 5 illustrates a perspective view of the alternate embodiment of the integrated toothbrush 100 without the floss cap in accordance with an embodiment.

The contour section has an upper edge and a lower edge. The upper edge of the contour section has a first vertex and a second vertex. The first vertex is adjacent to the middle body. The second vertex creates the lower end of the floss receptacle section. The lower edge connecting the first vertex and the second vertex at the bottom and is a level plane. The upper edge is a concave contour with indented slope between the first vertex and the second vertex enabling a user to seamlessly enter and exit the integrated device within the oral cavity. In one embodiment, the first vertex section of the toothbrush wider than the second vertex. In an alternate embodiment, the first vertex and the second vertex is of the same height. The contour between the between this first and second vertex is in the shape of a sickle.

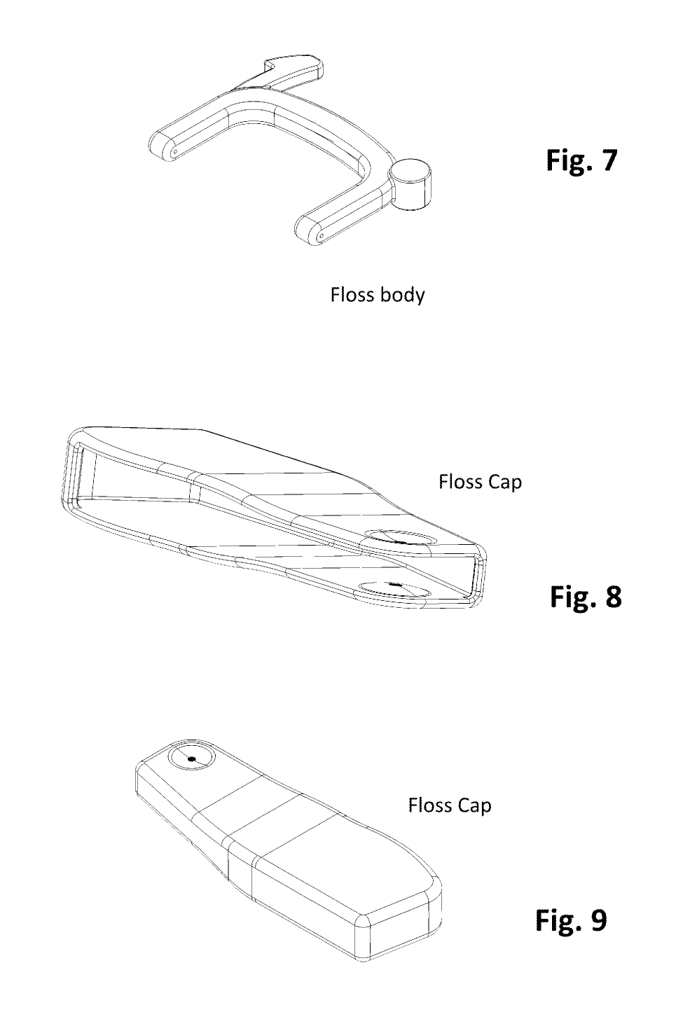

In accordance with an embodiment of the subject matter herein, the floss receptacle have an inner section and an outer section. The inner section of this floss receptacle is similar in shape to a bracket (“[”) with optional curved corners. The outer section of the body with having a level edge and a hook shaped end perpendicular to the level edge with curved corners. Furthermore, the floss assembly includes a floss body and a floss for flossing teeth. FIG. 6 illustrates a perspective view of a floss assembly in accordance with an embodiment. FIG. 7 illustrates a side perspective view of the floss assembly in accordance with an embodiment.

This floss body is also similar to a bracket “[” shape with curved corners so as to attach in the floss receptacle section. Moreover, the floss body has a first arm and a second arm with proximal end of each arms attached to the floss body. However, the distal end of these arms is a free end. The floss attached to the first arm and a second arm closer to the distal end. In one exemplary embodiment, the floss' first arm and the second arm are of equal lengths. Additionally, the length of the first arm and the second arm is at least twice the length of an arms of the floss receptacle section. The integrated apparatus wherein the floss is replaceably attached to the first arm and the second arm.

In one embodiment of the integrated apparatus for toothbrush and floss, the floss assembly is replaceably connected to the floss receptacle. The detachable floss assembly has a pivot part and a hook. The pivot part of the floss assembly gets connected to the pivot space of the receptacle section. Additionally, the hook is configured to be received in a catch part of the receptacle section.

The mechanism for attaching the receptacle section and the floss assembly includes steps of receiving the pivot within the pivot space and then snapping the hook to the catch. Conversely, the steps involved in the detachment mechanism for receptacle section and the floss assembly includes first dethatching the pivot and then removing the hook from the catch. In yet another embodiment of the integrated apparatus, the receptacle section may include a groove to accommodate the floss assembly.

FIG. 8 illustrates a perspective view of a floss cap showing open sides in accordance with an embodiment. FIG. 9 illustrates a perspective view of the floss cap showing closed sides in accordance with an embodiment. In one embodiment the floss cap is detachable. The floss cap matches an ornamental design of the outer shape of the floss assembly and is build to snugly fit the toothbrush body enclosing the floss assembly. The floss cap having two lips to encompass the floss assembly. The floss lips having two long sides and two short sides. One long side and one short side connected together with a continuous strip. For example, the strip having a thickness equal to the thickness of the toothbrush, the lips and the strip side forming an enclosure with two side open. The floss cap partially enclosed third side continuous strip. The floss cap has a plurality of bulge towards inner ends of the lips includes a hinged lips rotatable over a plurality of matching depression on the brush body.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions, types of materials and coatings described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or apparatuss and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. An integrated apparatus for toothbrush and floss is provided, the integrated apparatus comprises:
a toothbrush having a first end and a second end; between the first and the second end of the toothbrush comprises a head, a middle body and a lower body; the head being towards the first end, the lower body towards the second end, the middle body placed between the head and the lower body providing grip area for the apparatus;
a plurality of bristles placed above the head of the toothbrush towards the first end;
the lower body further comprising a contour section, and a floss receptacle section; and
a floss assembly comprising of a floss body and a floss, the floss assembly configured to attach to the floss receptacle section of the toothbrush.

2. The integrated apparatus of claim 1, wherein the contour section having a first vertex and a second vertex, the first vertex is adjacent to the middle body, the second vertex forming the lower end of the floss receptacle section.

3. The integrated apparatus of claim 2, wherein the first vertex section of the toothbrush wider than the second vertex.

4. The integrated apparatus of claim 2, wherein the first vertex and the second vertex is of the same height forming a sickle shaped contour.

5. The integrated apparatus of claim 2, wherein the contour section further comprises an upper edge and a lower edge, the lower edge connecting the first vertex and the second low forming a level plane, the upper edge forming a concave indented slope between the first vertex and the second vertex.

6. The integrated apparatus of claim 2, wherein the contour section configuration enabling user to seamlessly enter and exit the oral cavity.

7. The integrated apparatus of claim 1, wherein the floss receptacle having an inner section similar to a bracket “[” shape with curved corners and outer section of the body with having a level edge and a hook shaped end perpendicular to the level edge with curved corners.

8. The integrated apparatus of claim 1, wherein the floss assembly having a floss body and a floss; the floss body similar to a bracket “[” shape with curved corners, configured to be received in the floss receptacle section; the floss body having a first arm and a second arm, each arm's proximal end attached to the floss body, the distal free end, the floss attached to the first arm and a second arm closer to the distal end.

9. The integrated apparatus of claim 8, wherein the floss first arm and the floss second arm are of equal length and at least twice the length of an arms of the floss receptacle section.

10. The integrated apparatus of claim 8, wherein the floss is replaceably attached to the first arm and the second arm.

11. The integrated apparatus of claim 1, wherein the floss assembly is replaceably connected to the floss receptacle.

12. The integrated apparatus of claim 11, wherein the detachable floss assembly having a pivot part and a hook, the receptacle section further configured to provide an pivot space to receive the pivot part and a catch for receiving the hook.

13. The integrated apparatus of claim 11, wherein the attachment mechanism for receptacle section and the floss assembly comprises receiving the pivot within the pivot space and then snapping the hook to the catch.

14. The integrated apparatus of claim 11, wherein the detachment mechanism for receptacle section and the floss assembly comprises first dethatching the pivot and then removing the hook from the catch.

15. The integrated apparatus of claim 1, wherein the receptacle section comprises a groove to accommodate the floss assembly.

16. The integrated apparatus of claim 1 further comprising a floss cap having an ornamental design in the outer shape of the floss assembly, the floss cap configured to snugly fit the toothbrush body enclosing the floss assembly.

17. The integrated apparatus of claim 16, wherein the floss cap having two lips to encompass the floss assembly, the floss lips having two long sides and two short sides, wherein the one long side and one short side connected together with a continuous strip, the strip having a thickness equal to the thickness of the toothbrush, the lips and the strip side forming an enclosure with two side open.

18. The integrated apparatus of claim 17, wherein the floss cap partially enclosed third side continuous strip.

19. The integrated apparatus of claim 17, wherein the floss cap having a plurality of bulge towards inner ends of the lips comprises a hinged lips rotatable over a plurality of matching depression on the brush body.

20. The integrated apparatus of claim 16, wherein the floss cap is detachable.
